(19) United States
(12) Patent Application Publication
(10) Pub. No.: US 2026/0222895 A1
(43) Pub. Date: Jul. 30, 2026

(54) PACKET DATA CONVERGENCE PROTOCOL (PDCP) CONCATENATION AND QUALITY OF SERVICE (QOS) HEADER GENERATION

(71) Applicant: QUALCOMM Incorporated, San Diego, CA (US)

(72) Inventors: Sherif ELAZZOUNI, San Diego, CA (US); Sitaramanjaneyulu KANAMARLAPUDI, San Diego, CA (US); Gavin Bernard HORN, La Jolla, CA (US); Ozcan OZTURK, San Diego, CA (US)

(21) Appl. No.: 19/040,429

(22) Filed: Jan. 29, 2025

(51) Int. Cl. H04W 28/02; H04W 12/03; H04W 76/20

(52) U.S. Cl. CPC H04W 28/0268; H04W 12/03; H04W 76/20

(57) ABSTRACT

Methods, systems, and devices for wireless communications are described. A device supporting a wireless transmission may obtain (e.g., at a packet data convergence protocol (PDCP) entity) a set of service data units (SDUs) for communication to another device (e.g., a receiving device). The device may concatenate the set of SDUs and append one or more quality of service (QoS) headers with the concatenated plurality of service data units at the PDCP entity. Such techniques may support a protocol stack configuration that reduces (e.g., eliminates) a service data adaptation protocol (SDAP) layer and associated headers, and instead implements QoS header functionality at a PDCP layer. The device may cipher the concatenated set of SDUs at the PDCP entity, and may output a protocol data unit (PDU) that includes the one or more QoS headers and the ciphered concatenated set of SDUs.

### FIELD OF TECHNOLOGY

The following relates to wireless communications, including packet data convergence protocol (PDCP) concatenation and quality of service (QoS) header generation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by an apparatus is described. The method may include obtaining, at a packet data convergence protocol (PDCP) entity, a set of multiple service data units (SDUs), concatenating, at the PDCP entity, the set of multiple SDUs, appending, at the PDCP entity, one or more quality of service (QoS) headers with the concatenated set of multiple SDUs, ciphering, at the PDCP entity, the concatenated set of multiple SDUs, and outputting, from the PDCP entity, a protocol data unit (PDU) including the one or more QoS headers and the ciphered concatenated set of multiple SDUs.

An apparatus for wireless communications is described. The apparatus may include one or more memories storing processor executable code, and one or more processors coupled with the one or more memories. The one or more processors may individually or collectively be operable to execute the code to cause the apparatus to obtain, at a PDCP entity, a set of multiple SDUs, concatenate, at the PDCP entity, the set of multiple SDUs, appending, at the PDCP entity, one or more QoS headers with the concatenated set of multiple SDUs, cipher, at the PDCP entity, the concatenated set of multiple SDUs, and output, from the PDCP entity, a PDU including the one or more QoS headers and the ciphered concatenated set of multiple SDUs.

Another apparatus for wireless communications is described. The apparatus may include means for obtaining, at a PDCP entity, a set of multiple SDUs, means for concatenating, at the PDCP entity, the set of multiple SDUs, means for appending, at the PDCP entity, one or more QoS headers with the concatenated set of multiple SDUs, means for ciphering, at the PDCP entity, the concatenated set of multiple SDUs, and means for outputting, from the PDCP entity, a PDU including the one or more QoS headers and the ciphered concatenated set of multiple SDUs.

A non-transitory computer-readable medium storing code for wireless communications is described. The code may include instructions executable by one or more processors to obtain, at a PDCP entity, a set of multiple SDUs, concatenate, at the PDCP entity, the set of multiple SDUs, appending, at the PDCP entity, one or more QoS headers with the concatenated set of multiple SDUs, cipher, at the PDCP entity, the concatenated set of multiple SDUs, and output, from the PDCP entity, a PDU including the one or more QoS headers and the ciphered concatenated set of multiple SDUs.

In some examples of the method, apparatus, and non-transitory computer-readable medium described herein, appending the one or more QoS headers may include operations, features, means, or instructions for appending the one or more QoS headers with one or more concatenation headers, where each QoS header follows a respective concatenation header of the one or more concatenation headers for a respective SDU of the set of multiple SDUs.

In some examples of the method, apparatus, and non-transitory computer-readable medium described herein, appending the one or more QoS headers may include operations, features, means, or instructions for appending the one or more QoS headers with a concatenation header associated with the set of multiple SDUs, where the one or more QoS headers follow the concatenation header.

In some examples of the method, apparatus, and non-transitory computer-readable medium described herein, appending, at the PDCP entity, one or more concatenation headers associated with the concatenated set of multiple SDUs, where, for each of the set of multiple SDUs, a respective concatenation header includes an indication of whether a respective QoS header may be included for a respective SDU in the one or more QoS headers.

In some examples of the method, apparatus, and non-transitory computer-readable medium described herein, the indication indicates whether the respective QoS header may be shared for the respective SDU and at least one SDU different than the respective SDU in the concatenated set of multiple SDUs.

In some examples of the method, apparatus, and non-transitory computer-readable medium described herein, the set of multiple SDUs include one or more groups of SDUs, each group of the one or more groups of SDUs corresponding to respective QoS headers of the one or more QoS headers, and each group of the one or more groups of SDUs may be associated with a SDU quantity indicator and a packet length indicator.

In some examples of the method, apparatus, and non-transitory computer-readable medium described herein, the SDU quantity indicator indicates a quantity of SDUs that correspond to a same QoS header, and the packet length indicator indicates quantity of bytes associated with the quantity of SDUs that correspond to the same QoS header.

Some examples of the method, apparatus, and non-transitory computer-readable medium described herein may further include operations, features, means, or instructions for appending one or more concatenation headers at the PDCP entity, where, for a respective group of SDUs, a respective concatenation header includes an indication of whether a respective QoS header may be shared between SDUs of the respective group of SDUs.

In some examples of the method, apparatus, and non-transitory computer-readable medium described herein, the one or more QoS headers include at least a portion of a PDCP header, the PDCP header including a length field indicative of a total length of the PDCP header.

Some examples of the method, apparatus, and non-transitory computer-readable medium described herein may further include operations, features, means, or instructions for outputting, via control signaling, a reflective QoS indicator (RQI), a reflective QoS to data radio bearer (DRB) mapping indicator (RDI), or both, to indicate a mapping of the one or more QoS headers with the concatenated set of multiple SDUs.

In some examples of the method, apparatus, and non-transitory computer-readable medium described herein, the control signaling includes radio resource control (RRC) signaling, medium access control-control element (MAC-CE) signaling, PDCP signaling, or any combination thereof.

In some examples of the method, apparatus, and non-transitory computer-readable medium described herein, ciphering the concatenated set of multiple SDUs may include operations, features, means, or instructions for ciphering the concatenated set of multiple SDUs together with the one or more QoS headers.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports packet data convergence protocol (PDCP) concatenation and quality of service (QoS) header generation in accordance with one or more aspects of the present disclosure.

FIG. 2 shows an example of a PDCP concatenation configuration that supports PDCP concatenation and QoS header generation in accordance with one or more aspects of the present disclosure.

FIG. 3 shows examples of concatenated service data unit (SDU) configurations that support PDCP concatenation and QoS header generation in accordance with one or more aspects of the present disclosure.

FIGS. 4 and 5 show examples of packet data unit (PDU) configurations that support PDCP concatenation and QoS header generation in accordance with one or more aspects of the present disclosure.

FIG. 6 shows an example of a process flow that supports PDCP concatenation and QoS header generation in accordance with one or more aspects of the present disclosure.

FIGS. 7 and 8 show block diagrams of devices that support PDCP concatenation and QoS header generation in accordance with one or more aspects of the present disclosure.

FIG. 9 shows a block diagram of a communications manager that supports PDCP concatenation and QoS header generation in accordance with one or more aspects of the present disclosure.

FIG. 10 shows a diagram of a system including a UE that supports PDCP concatenation and QoS header generation in accordance with one or more aspects of the present disclosure.

FIG. 11 shows a diagram of a system including a network entity that supports PDCP concatenation and QoS header generation in accordance with one or more aspects of the present disclosure.

FIG. 12 shows a flowchart illustrating methods that support PDCP concatenation and QoS header generation in accordance with one or more aspects of the present disclosure.

### DETAILED DESCRIPTION

In some wireless communications systems, a transmitting device (e.g., a device supporting or performing a wireless transmission, a transmitting entity, a transmitting protocol entity, a user equipment (UE), a network entity, one or more components of a network entity) may process data for transmission in accordance with one or more layers of a protocol stack (e.g., a control plane protocol stack, a user plane protocol stack), which may include a packet data convergence protocol (PDCP) layer. A PDCP layer may support transferring data (e.g., via protocol data units (PDUs)) by performing ciphering and integrity protection on the data, applying a PDCP header to the data, and outputting the data via a PDCP PDU for downstream transmission to a receiving device (e.g., a device supporting or performing a wireless reception, a receiving entity, a receiving protocol entity, another UE, a network entity, another component of a network entity). Inputs to a PDCP layer may be referred to as service data units (SDUs) (e.g., PDCP SDUs), and the transmitting device may perform PDCP layer processing (e.g., integrity protection and ciphering) on each SDU that is input to the PDCP layer or on sets of concatenated SDUs. For example, in order to reduce transmission overhead, the transmitting device may concatenate (e.g., combine, sequence) multiple SDUs into a single concatenated SDU. In some cases, however, positioning of a PDCP header within a PDCP PDU relative to concatenated SDUs may cause challenges for integrity protection, ciphering, and deciphering for the concatenated SDUs. For example, some headers (e.g., service data adaptation protocol (SDAP) headers, quality of service (QoS) headers) should not undergo ciphering, or ciphering of the headers may increase processing and deciphering burden for a receiving device.

In accordance with aspects as disclosed herein, a transmitting device may support various header placements and ciphering techniques for a PDCP PDU to reduce processing complexity and transmission or reception overhead. For example, some header functionality, such as QoS header generation, may be implemented in a PDCP layer (e.g., eliminating an SDAP layer, replacing aspects of an SDAP header, absorbing functionality of an SDAP layer into a PDCP layer), which may support efficient ciphering and integrity protection of concatenated SDUs. For example, a QoS header may follow concatenation sub-headers for each SDU, or a QoS header can follow a full concatenation header. In some aspects, a concatenation header may include a bit to indicate whether a QoS header is included in the concatenation header for a corresponding SDU, and can also indicate whether a QoS header is the same for the corresponding SDU and a previous SDU, which may reduce the total quantity of QoS headers included in the concatenation header. Additionally, or alternatively, the transmitting device may represent concatenated packets belonging to the same QoS flow by representing each group of SDUs belonging to the same QoS flow using pairs of (N: Number or quantity of packets, L: Length of packet), so that groups of equal length packets may be represented in a condensed format.

Particular aspects of the subject matter described in this disclosure can be implemented to realize one or more of the following potential advantages. In some examples, the techniques described herein may support reduced processing (e.g., layer-2 (L2) processing) by reducing the total quantity of headers included in a PDCP header, and reducing ciphering and integrity protection operations performed by a transmitting device at the PDCP layer (e.g., by allowing for concatenating the SDUs prior to processing). Additionally, or alternatively, the techniques described herein may reduce header overhead, including for applications with relatively small packet lengths, such as voice and gaming-type packets. Additionally, or alternatively, the techniques described herein may support reduced complexity for ciphering (e.g., at a transmitting device) and deciphering (e.g., at a receiving device), while supporting secure transmission of ciphered packets.

Aspects of the disclosure are initially described in the context of wireless communications systems. Aspects of the disclosure are further illustrated by and described with reference to PDCP concatenation configurations, PDU configurations, process flows, apparatus diagrams, system diagrams, and flowcharts that relate to PDCP concatenation and QoS header generation.

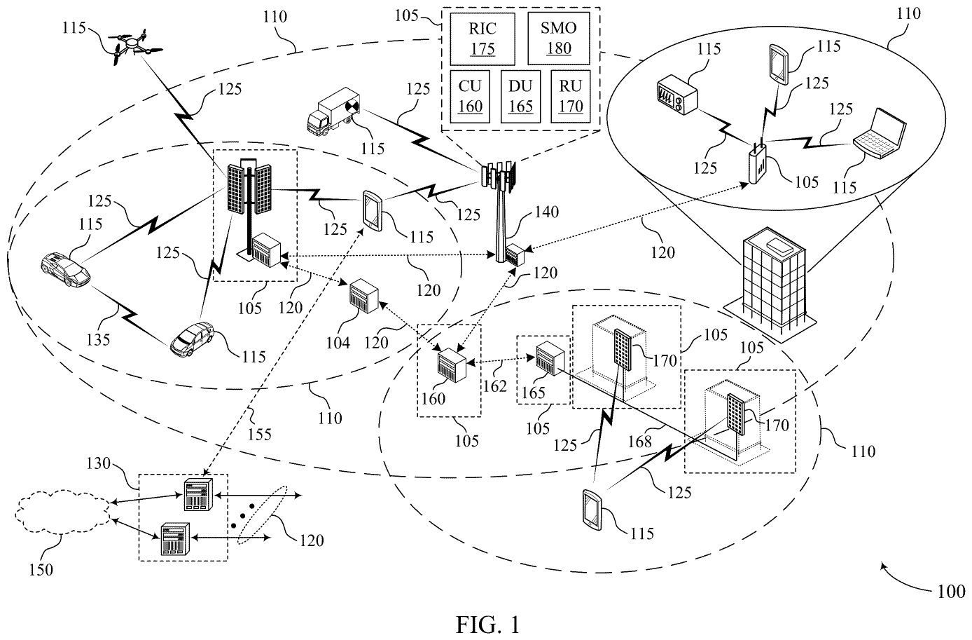

FIG. 1 shows an example of a wireless communications system 100 that supports PDCP concatenation and QoS header generation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160.

Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support PDCP concatenation and QoS header generation as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

Each of the network entities 105 of the wireless communications system (e.g., CUs 160, DUs 165, RUs, Non-RT RICs, Near-RT RICs, SMOs, Open Clouds (O-Clouds), Open eNBs (O-eNBs)) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160 may host one or more higher layer control functions. Such control functions may include RRC, PDCP, SDAP, or the like. Each control function may be implemented with an interface configured to communicate signals with other control functions hosted by the CU 160. A CU 160 may be configured to handle user plane functionality (e.g., CU-UP), control plane functionality (e.g., CU-CP), or a combination thereof. In some examples, a CU 160 may be logically split into one or more CU-UP units and one or more CU-CP units. A CU-UP unit may communicate bidirectionally with the CU-CP unit via an interface, such as an E1 interface when implemented in an O-RAN configuration. A CU 160 may be implemented to communicate with a DU 165, as necessary, for network control and signaling.

A DU 165 may correspond to a logical unit that includes one or more functions (e.g., base station functions, RAN functions) to control the operation of one or more RUs 170. In some examples, a DU 165 may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165 may further host one or more low PHY layers. Each layer may be implemented with an interface configured to communicate signals with other layers hosted by the DU 165, or with control functions hosted by a CU 160.

In some examples, lower-layer functionality may be implemented by one or more RUs 170. For example, an RU 170, controlled by a DU 165, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170 may be implemented to handle over the air (OTA) communication with one or more UEs 115. In some implementations, real-time and non-real-time aspects of control and user plane communication with the RU(s) 170 may be controlled by the corresponding DU 165. In some examples, such a configuration may enable a DU 165 and a CU 160 to be implemented in a cloud-based RAN architecture, such as a vRAN architecture.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates in accordance with a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, a transmitting device (e.g., a device supporting or performing a wireless transmission, a transmitting entity, a UE 115, a network entity 105, one or more components of a network entity 105, a CU 160) may process data for transmission in accordance with one or more layers of a protocol stack as described herein. For example, the transmitting device may support L2 functionality and signaling, which may include PDCP or SDAP functions, voice over internet protocol (VOIP), non-terrestrial network (NTN) implementations, among other deployments. The transmitting device may identify SDUs at the PDCP layer (e.g., protocol data units (PDUs) received from a previous layer, such as an RRC layer) and may perform one or more PDCP functions on the SDUs. For example, the transmitting device may perform integrity protection on PDCP SDUs, such as by a user plane integrity protection (UPIP) function or other security algorithm-based invocations, which may support the transmitting device communicating at a desired data rate (e.g., UPIP may be mandatory for the transmitting device to maintain a full data rate). In some examples, signaling overhead may be reduced by adding PDCP, RLC, and MAC headers for each SDU communicated in the system. In some cases, however, a throughput of the transmitting device may be associated with (e.g., limited by) a quantity of the SDUs due to performing PDCP layer functions on each SDU individually. For example, some functions (e.g., cryptographic processing) may include initialization and security key setup procedures, and the transmitting device may communicate with hardware accelerators at a relatively high rate (e.g., increasing a load on hardware even if the hardware is capable of supporting larger SDU sizes).

Some protocol stacks may include an SDAP layer, which may be a topmost layer of the protocol stack (e.g., positioned above a PDCP layer). An SDAP layer may support QoS flows in Non-Access Stratum (NAS) signaling. For example, the SDAP layer may map QoS flows to data radio bearers (DRBs) and may support QoS at the PDU session level. In some examples, the SDAP layer may map QoS flows (e.g., including information regarding performance requirements) to respective DRBs, where each DRB may have different or distinct capabilities in handling different types of data traffic based on latency, data rate, reliability, among other quality-based metrics. In some examples, reflective QoS may be supported to dynamically switch QoS flows based on different (e.g., observed) traffic and scheduling characteristics. Additionally, or alternatively, the SDAP layer may mark packets (e.g., downlink and uplink packets) with QoS flow identifiers (QFIs) which may support accurate application of different QoS rules to different QoS flows. In some examples, the SDAP layer may be configured for one or more DRBs, with each DRB being capable of supporting one or more QoS flows. A UE 115 or a network entity 105 may support one or more SDAP layers, each of which corresponds to a respective SDAP entity, with each respective SDAP entity corresponding to a respective PDU session.

In accordance with some protocol stacks, for a QoS flow, an SDAP entity may receive or deliver SDAP SDUs from or to upper layers and may submit or receive SDAP data PDUs to or from a peer SDAP entity via lower layers. For a transmission, a transmitting SDAP entity may obtain an SDAP SDU from upper layers, and may construct a corresponding SDAP data PDU (e.g., using a mapping of the QoS flow to a DRB, an MRB, and/or a sidelink DRB), may optionally add an SDAP header (if configured), and may submit or output the SDAP PDU to lower layers (e.g., a radio interface such as a Uu link or PC5 link). At the receiving side, when a receiving SDAP entity receives an SDAP data PDU from lower layers, the receiving SDAP entity may retrieve the corresponding SDAP SDU and may (optionally) perform a reflective QoS flow to DRB mapping, may (optionally) remove the SDAP header (e.g., if the SDAP header is present for the SDAP data PDU), and may deliver or output the SDAP data PDU to upper layers.

To reduce latency associated with individually processing PDCP SDUs, a transmitting device may concatenate one or more sets of SDUs and may perform PDCP processing on the concatenated SDUs. A concatenated SDU, as described herein, may refer to a set of multiple SDUs that are concatenated or combined together. For example, the transmitting device may input a set of multiple SDUs to a concatenation buffer at the PDCP layer, which may concatenate the multiple SDUs into a single concatenated SDU (e.g., a pseudo SDU including each SDU input to the concatenation buffer). Additionally, or alternatively, multiple concatenation buffers may be configured to concatenate SDUs according to a RLC entity, a QoS flow, or both associated with the SDUs (e.g., the transmitting device may route SDUs to a concatenation buffers according to RLC entity and QoS flow). By implementing multiple concatenation buffers at the PDCP layer, latency, L2 processing time, and overhead associated with PDCP processing may be reduced (e.g., especially for applications with relatively small packet size such as for voice data and gaming applications), thereby improving a throughput of the transmitting device. Additionally, or alternatively, SDU concatenation may reduce hardware burden (e.g., burden for hardware accelerators) at wireless devices within the wireless communications system 100, such that the hardware performs user plane integrity protection and ciphering for each group of concatenated SDUs, rather than for each individual SDU.

In some cases, however, a transmitting device may experience challenges when performing protection and ciphering for a group of concatenated SDUs that include PDCP headers, SDAP control PDUs, or both, located within the concatenated SDUs, because both the PDCP headers and the SDAP control PDUs may not undergo ciphering. Additionally, or alternatively, PDCP concatenation may face compatibility challenges with SDAP headers (e.g., processing of SDAP headers may be challenging, which may increase security challenges), and interleaved SDAP headers, which may not be ciphered, may increase ciphering continuity challenges and increase hardware burden to cipher the SDU payload (e.g., while not ciphering the SDAP header).

To support efficient handling of PDCP headers and control PDUs located within a PDCP PDU, a transmitting device may identify one or more different configured locations for placement of headers and control PDUs within a PDCP PDU and, in some cases, the generation of QoS control and headers may be consolidated at the PDCP layer. In some such examples, the transmitting device may place the headers and the control PDUs such that the headers and the control PDUs do not undergo ciphering. Additionally, or alternatively, functionality otherwise associated with an SDAP layer may be combined with or absorbed in the PDCP layer, which may allow for simplified header processing and increased support for PDU discard based on time and PDU importance at the PDCP layer.

In order to support efficient ciphering and integrity protection of concatenated SDUs, a transmitting device may support various header placements, including replacement of the SDAP header (and various ciphering techniques) for a PDCP PDU to reduce processing complexity and transmission overhead. For example, some header functionality, such as QoS header generation, may be moved to the PDCP layer (e.g., eliminating an SDAP layer, replacing aspects of an SDAP header, absorbing functionality of an SDAP layer into a PDCP layer). For example, a QoS header may follow concatenation sub-headers for each SDU, or a QoS header can follow a full concatenation header. In some aspects, a concatenation header may include a bit to indicate whether a QoS header is included in the concatenation header for a corresponding SDU, and can also indicate whether a QoS header is the same for the corresponding SDU and a previous SDU, which may reduce the total quantity of QoS headers included in the concatenation header. Additionally, or alternatively, the transmitting device may represent concatenated packets belonging to the same QoS flow by representing each group of SDUs belonging to the same QoS flow using pairs of (N: Number of packets, L: Length of packet), so that groups of equal length packets may be represented in a condensed format.

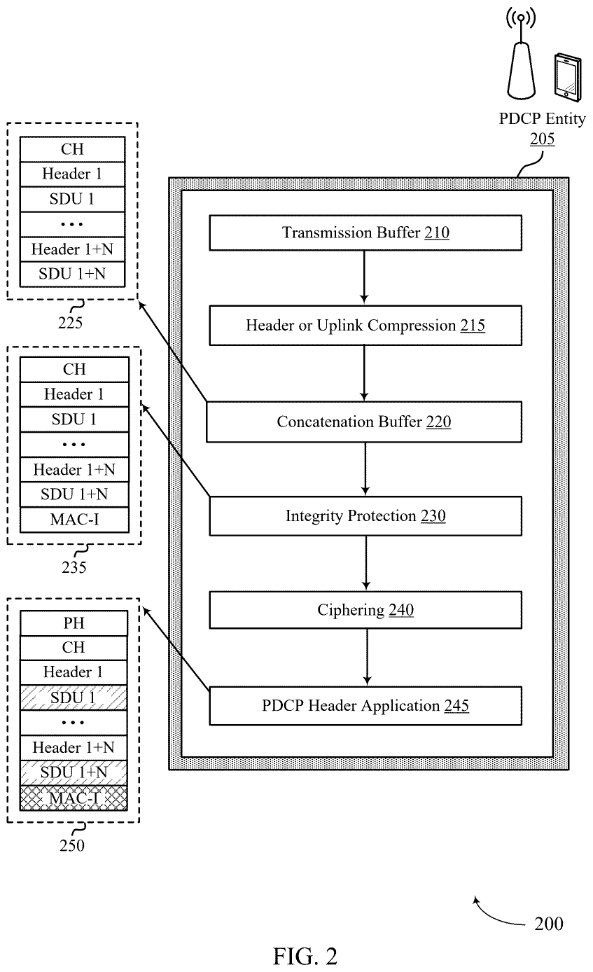

FIG. 2 shows an example of a PDCP concatenation configuration 200 that supports PDCP concatenation and QoS header generation in accordance with one or more aspects of the present disclosure. For example, the PDCP concatenation configuration 200 shows functionality associated with a PDCP layer at a transmitting device (e.g., at a PDCP entity 205 of the transmitting device), which may be an example of a UE 115 or a network entity 105 (e.g., a base station 140, a CU 160).

In some cases, a transmitting device may identify (e.g., receive) one or more SDUs at the PDCP entity 205 (e.g., a PDCP transmission entity), and such SDUs may include data for transmission to a receiving device. For example, the transmitting device may receive the SDUs from a different or higher layer of the protocol stack (e.g., an RRC layer, an SDAP layer, a QoS layer, a higher layer protocol entity), which may be initially stored in a transmission buffer 210. In some cases, the transmitting device may perform sequence numbering to order the SDUs (e.g., numerically, relationally) in the transmission buffer 210. For example, the transmitting device may apply a first sequence number (SN) to a first SDU in the transmission buffer 210, apply a second SN to a second SDU in the transmission buffer 210, and so on. After storing the one or more SDUs in the transmission buffer 210, the transmitting device may apply header or uplink compression 215 to the ordered SDUs from the transmission buffer 210. In some examples, the transmitting device may perform header compression or uplink data compression to the SDUs in order to reduce a relative size of the SDUs (e.g., to conserve radio resources and signaling overhead). For example, if a size of a header of an SDU is relatively large compared to a data portion of the SDU, the transmitting device may apply header compression to the SDU (e.g., via robust header compression (ROHC)). Additionally, or alternatively, if the SDUs are associated with uplink data, the transmitting device may apply an uplink data compression function (which may be preconfigured for a DRB) to the SDUs.

In some examples, the transmitting device may route the SDUs into one or more concatenation buffers 220, which may concatenate the multiple SDUs into a concatenated SDU 225. For example, the transmitting device may use the one or more concatenation buffers 220 to obtain a concatenated SDU 225, which may include a concatenation of multiple SDUs (e.g., SDU 1 through SDU 1+N, where N may be a positive integer value) and corresponding headers 1 through 1+N, along with at least one concatenation header (e.g., CH). It should be noted that the transmitting device may support any quantity of concatenation buffers and is not limited to the quantity illustrated by the PDCP concatenation configuration 200.

For example, the transmitting device may input SDUs into the one or more concatenation buffers 220 until one or more parameters are satisfied, such as a concatenation timer expiring (e.g., t>concatenationTimer), a threshold concatenated SDU size being reached (e.g., SDU size>maxSDUSize), or both. In some examples, the concatenation timer may be set according to a threshold (e.g., maximum) allowable delay of the radio bearer or quality of service (QoS) flow, or may be set based on device implementation. In some examples, the threshold (e.g., maximum) SDU size may be determined based on device implementation or may be set according to a combination of factors including UE capability indicated by UE or network considerations (such as a lower bound on a grant size, channel occupancy time (COT) in an unlicensed band), among other factors. In some examples, the one or more concatenation buffers 220 may maintain a threshold concatenated SDU size (e.g., Concatenated_SDU_Size), which may be indicative of a cumulative size of data (e.g., bytes) of the total quantity of SDUs in the one or more concatenation buffers 220.

In some cases, the transmitting device may perform one or more PDCP layer functions on the one or more concatenated SDUs 225. For example, the transmitting device may perform integrity protection 230 on the one or more concatenated SDUs 225 to verify the concatenated SDUs, and may apply a message authentication code integrity (MAC-I) field to each concatenated SDU 225 verified via the integrity protection 230, to form a set of authenticated SDUs 235. Additionally, the transmitting device may perform ciphering 240 on the one or more concatenated SDUs 225 to prepare the concatenated SDUs 225 for transmission to a receiving device (e.g., encoding data associated with the concatenated SDUs). In some cases, performing the PDCP entity 205 functions (e.g., integrity protection 230 and ciphering 240) on the concatenated SDUs 225 instead of on each individual SDU may reduce a quantity and frequency of hardware invocations at the transmitting and/or receiving device, overhead associated with the PDCP entity 205 (e.g., UPIP overhead), latency associated with processing data (e.g., cryptographic processing time), or any combination thereof, among other benefits.

In some examples, after performing the PDCP entity 205 functions on the one or more concatenated SDUs 225 (e.g., after generating authenticated SDUs 235), the transmitting device may perform PDCP header application 245 to the one or more concatenated SDUs. Alternatively, the transmitting device may perform PDCP header application 245 to one or more SDUs following the header or uplink compression 215 (e.g., without routing the SDUs through the one or more concatenation buffers 220, the integrity protection 230, and the ciphering 240). In some cases, adding a PDCP header to an SDU may convert the SDU into a PDCP PDU 250. For example, the one or more concatenated SDUs 225 may become a PDCP PDU 250 after PDCP header application 245. In some examples, the transmitting device may perform routing and duplication on the PDCP PDUs 250 based on adding the PDCP headers, which may route the PDCP PDUs to an intended radio bearer and duplication of PDCP PDUs 250 for transmission to different radio bearers (e.g., if a split bearer configuration is enabled).

In some cases, the transmitting device may transmit one or more messages including PDCP PDUs 250 to a receiving device via a Uu or PC5 radio interface. In some examples, the transmitting device or another downstream device may perform additional processing on PDCP PDUs 250 according to one or more subsequent layers of the protocol stack (e.g., using one or more downstream protocol layer entities), such as an RLC layer and a MAC layer, before associated messages are transmitted (e.g., wirelessly) via a PHY layer (e.g., the Uu or PC5 radio interface). In some cases, the receiving device may process and decode the one or more concatenated PDUs according to functions of the PDCP entity 205 (e.g., at a PDCP reception entity). For example, the receiving device may remove PDCP headers from PDCP PDUs 250 to obtain one or more concatenated SDUs 225 (e.g., corresponding to concatenated SDUs 225 output from the one or more concatenation buffers 220). In some aspects, the PDCP entity 205 may perform various PDCP sub-layer functions (e.g., sequence numbering, header compression and/or decompression, ciphering, deciphering, integrity protection, timer-based SDU discard, user plane data transfer, control plane data transfer, among other functionalities), and may be configured for transmission and reception of data (e.g., for a bidirectional radio bearer), or for one of transmission or reception of data (e.g., for a unidirectional radio bearer).

The receiving device may perform decoding to obtain the one or more concatenated SDUs 225 by performing deciphering (e.g., an inverse of the ciphering 240) and may perform a verification to obtain the one or more concatenated SDUs 225 by performing integrity verification (e.g., confirming the MAC-I field output from the integrity protection 230). In some examples, the receiving device may input the decoded concatenated SDUs 225 into a reception buffer to separate the concatenated SDUs 225 into individual SDUs, reorder the SDUs (e.g., according to SNs included in the concatenated SDUs), and discard any duplicate SDUs. The receiving device may then perform header or uplink decompression on the SDUs to obtain the SDUs initially generated by the transmitting device.

In some implementations, the positioning of the PDCP header within the PDCP PDU relative to the concatenated SDUs 225 may cause challenges for integrity protection 230 and ciphering 240 for the concatenated SDUs 225, because ciphering 240 (and deciphering) may only apply to data portions of the PDCP PDU. That is, the PDCP headers and control PDUs may not undergo ciphering (e.g., ciphering may not apply to headers or to the control PDUs).

In accordance with aspects as described herein, a transmitting device may support various header placements (and ciphering techniques) for a PDCP PDU to reduce processing including ciphering and deciphering complexity. For example, some header functionality, such as QoS header generation may be implemented in the PDCP layer (e.g., by a PDCP entity, eliminating an SDAP layer, replacing aspects of an SDAP header, absorbing functionality of an SDAP layer into the PDCP layer), which may support efficient ciphering and integrity protection of concatenated SDUs. Additionally, or alternatively, a QoS header may follow concatenation sub-headers for each SDU, or a QoS header may follow a full concatenation header. In some such examples, a concatenation header may include a bit to indicate whether a QoS header is included for an SDU or not, and may also indicate whether a QoS header is the same for the SDU and a previous SDU. Additionally, or alternatively, concatenated packets belonging to the same QoS flow may be represented as a group of SDUs belonging to the same QoS flow using a pair of (N: Number of packets, L: Length of packet), so that groups of equal length packets may be represented in a condensed format.

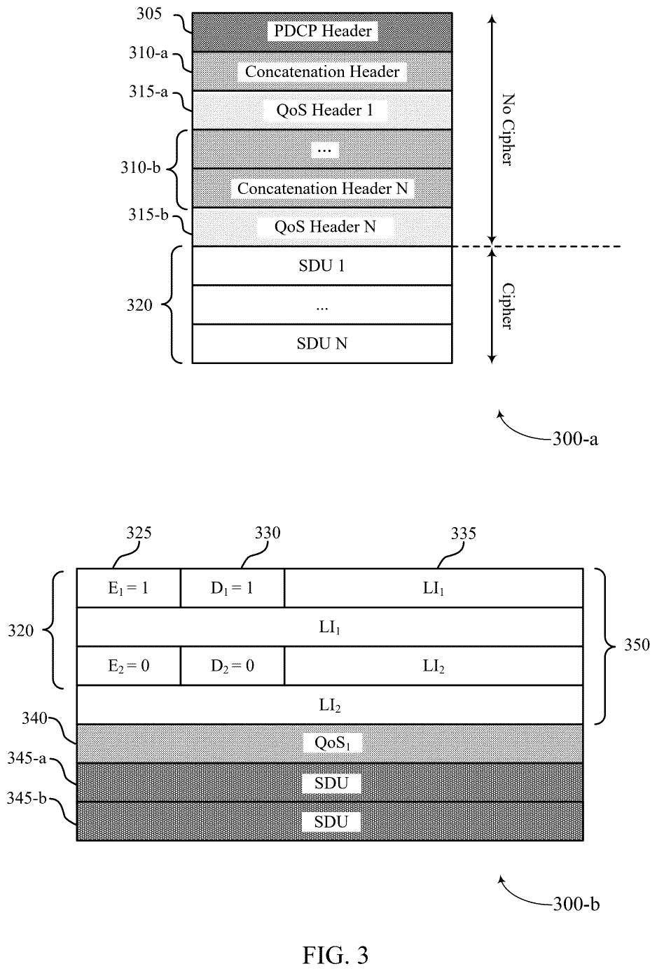

FIG. 3 shows an example of a concatenated SDU configuration 300-a and a concatenated SDU configuration 300-b that support PDCP concatenation and QoS header generation in accordance with one or more aspects of the present disclosure. The concatenated SDU configuration 300-a and the concatenated SDU configuration 300-b may be implemented at or by a transmitting device, such as a UE 115, a network entity 105 (e.g., a base station 140, a CU 160), or another device as described herein.

To reduce processing complexity, a transmitting device (e.g., a PDCP entity of the transmitting device) may implement the concatenated SDU configuration 300-a, where the QoS headers 315 may be positioned in the concatenated SDU configuration 300-a prior to the concatenated SDU 320 as part of the concatenation header. For example, a PDCP header 305, one or more concatenation headers (e.g., a first concatenation header 310-a, a set of concatenation headers 310-b), one or more QoS headers (e.g., a first QoS header 315-a, a QoS header N 315-b), may be appended to the concatenated SDU 320 (e.g., a concatenated SDU including SDU 1 through SDU N). A QoS header 315 (e.g., the first QoS header 315-a through the QoS header 315-b, each corresponding with respective SDUs in the concatenated SDU 320) may be positioned in the concatenated SDU configuration 300-a prior to the concatenated SDU 320. In some examples, the first QoS header 315-a may be grouped with the first concatenation header 310-a, which may correspond to the first SDU (e.g., SDU 1) of the concatenated SDU 320. Additional QoS headers may be grouped with additional concatenation headers, where each group of concatenation and QoS headers may correspond to respective SDUs of the concatenated SDU positioned after the headers. In such examples, the concatenation headers 310 may include an indication of the length of the concatenated SDU 320 plus the QoS header 315 if present. In cases that the QoS headers 315 are positioned prior to the concatenated SDU, the transmitting device may refrain from ciphering the first portion of the concatenated SDU (e.g., including PDCP headers 305, concatenation headers 310, and QoS headers 315), and may apply ciphering to the second portion of the concatenated SDU (including the concatenated SDU 320).

The transmitting device may additionally, or alternatively, implement a concatenated SDU configuration 300-b. In some aspects, header generation may be allocated to the PDCP layer (e.g., to the PDCP entity, eliminating or absorbing the SDAP layer). In some examples, a QoS header can follow the full concatenation header 350, and a DRB (having a QoS flow associated with the concatenated SDU configuration 300-b) may include QoS headers (such as the QoS header 340) that are either activated or deactivated. In some examples, the concatenation header may include a bit 330 (e.g., D₁, D₂, D_{N}) to indicate whether a QoS header 340 is included for a given SDU (or whether the QoS header 340 is not included for the given SDU). For example, when the bit 330 (e.g., D_{N}) is set to 1, a QoS header 340 may be present for a corresponding SDU, and when the bit 330 is set to 0, a QoS header 340 associated with the corresponding SDU may be omitted. For example, the concatenated SDU configuration 300-b illustrates two concatenated SDUs (e.g., a first SDU 345-a and a second SDU 345-b), where the first SDU 345-a is associated with a bit 330 value of 1 (e.g., D₁=1) in the full concatenation header 350, meaning that the first SDU 345-a has a QoS header 340 (e.g., QoS₁), and the second SDU 345-b has a bit 330 value of 0, meaning that the second SDU 345-b does not have an associated QoS header 340. The first and second SDUs may also be associated with a length field 335 (e.g., LI₁, LI₂, LIN), which may be indicative of the data length (e.g., in bytes) of data included for the SDU, such as the data length of the first SDU 345-a and the data length of the second SDU 345-b. The first and second SDUs may also be associated with a starting field 325 (e.g., E₁, E₂, E_{N}), where the starting field 325 may indicate whether the starting field 325 is the last field in the PDCP concatenation header, or whether other header fields are present. For example, the starting field 325 having a value of 1 indicates another concatenation field is present, and the starting field 325 having a value of 0 indicates that data follows (e.g., no other concatenation fields). A summary of different field values included in the QoS header placement configuration is given in Table 1, below:

TABLE 1

| SDU | E value | E value meaning | D value | D value meaning |
|---|---|---|---|---|
| 1 | E₁ = 1 | Another concatenation | D₁ = 1 | QoS header present |
| | | field follows | | for SDU |
| 2 | E₂ = 0 | Data follows, no other | D₂ = 0 | QoS header absent |
| | | concatenation fields | | for SDU |

It should be noted that the concatenated SDU configuration 300-b is an example configuration including two concatenated SDUs, and the described techniques are not limited to examples with two concatenated SDUs, and may be applied for other PDU configurations (e.g., including more or less than two concatenated SDUs).

In some examples, (e.g., based on QoS header generation being at the PDCP layer), one or more aspects of the QoS header may be included in control signaling. For example, a reflective QoS flow to DRB mapping indication (RDI), a reflective QoS indication (RQI), or both, may be signaled via RRC signaling, medium access control-control element (MAC-CE) signaling, or both. The RDI indicated by the control signaling may be a 1-bit message that instructs a UE to apply reflective QoS at the Access Stratum. The RQI indicated by the control signaling may be a 1 bit message that instructs the UE to apply reflective QoS at the Non-Access Stratum (NAS) layer.

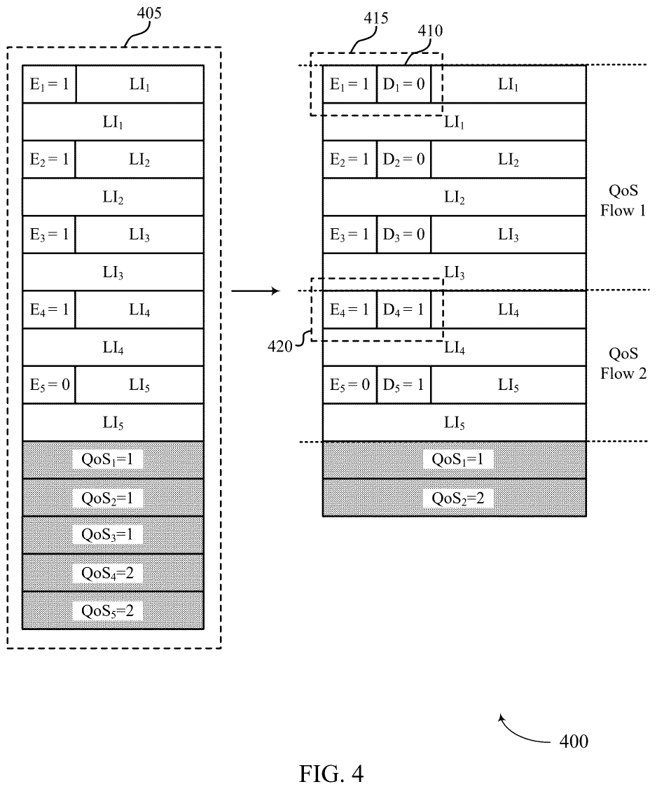

FIG. 4 shows an example of a PDU configuration 400 that supports PDCP concatenation and QoS header generation in accordance with one or more aspects of the present disclosure. For example, the PDU configuration 400 may be implemented at or by a transmitting device, such as a UE 115, a network entity 105 (e.g., a base station 140, a CU 160), or another device as described herein.

In some aspects, a transmitting device (e.g., a PDCP entity of the transmitting device) may concatenate a relatively large quantity of SDUs (e.g., 30 to 60 SDUs or more) to send in a single transmit block (e.g., transport block), which may be accompanied by a baseline header 405 (e.g., a PDCP PDU header portion, a concatenation and QoS header portion). In such cases, a baseline header 405 may have a correspondingly large quantity of fields (e.g., 30 to 60 fields, or more), and a correspondingly large quantity of QoS headers (e.g., 30 to 60 QoS headers, or more) which may lead to excess transmission overhead. For example, each “E” field and each “LI” field may have a corresponding “QoS” header. Having both a relatively large quantity of SDUs and a correspondingly large quantity of headers may increase bother transmission overhead and processing.

In some examples, a transmitting device may reduce the quantity of headers included in a transmit block (e.g., in a reduced concatenation and QoS header portion) in cases where the relatively large quantity of SDUs are associated with relatively few QoS flows (e.g., 1 or 2 QoS flows). For example, an indicator bit 410 (e.g., a “D” bit) may be included in a concatenation header 415, where the indicator bit 410 indicates whether the SDU shares the same QoS header (e.g., has the same QoS flow indicator (QFI)) as a previous SDU in the concatenated SDU. For example, for the first QoS flow (e.g., QoS flow 1), the first SDU, the second SDU, and the third SDU (corresponding to LI₁, LI₂, and LI₃) may be indicated as sharing the same QoS header, because each D bit is the same for the first SDU, the second SDU, and the third SDU (e.g., D=0). That is, if the D bit is the same, then the same QoS header is shared between the current and previous SDU in the concatenated SDU.

In some aspects, however, if the D bit is toggled (e.g., as in the concatenation header 420), then the SDU having the toggled D bit has a separate QoS header from the previous SDU. In such examples, the toggled D bit (e.g., between the third SDU and the fourth SDU) may indicate a different QoS flow (e.g., QoS flow 2) for the fourth SDU. The mapping between the SDU number and the corresponding QoS flow may be illustrated by Table 2, below:

TABLE 2

| SDU Number | QoS Flow |
|---|---|
| 1 | 1 |
| 2 | 1 |
| 3 | 1 |
| 4 | 2 |
| 5 | 2 |

In such examples, the D bit may consolidate the mapping between the QoS headers and SDUs (e.g., a 1-to-1 mapping between QoS headers and concatenated SDUs may be eliminated, which may reduce signaling overhead). For example, a relatively large quantity of SDUs (e.g., 30 SDUs) that belong to a single QoS flow may be represented by a single QoS header (e.g., rather than a correspondingly large quantity of QoS headers). Additionally, or alternatively, if the relatively large quantity of SDUs (e.g., 30 SDUs) belong to two QoS flows, the SDUs may be represented by as few as two QoS headers and so on. The reduction or consolidation of QoS headers per QoS flow may reduce overhead and processing burden at both the transmitting device and a receiving device.

Additionally, or alternatively, the PDCP header may indicate an overall header length field, which may indicate the entire length of the PDCP header (including the concatenation header and QoS headers). In such examples, a receiving device may receive the concatenated SDU, and may be able to isolate the PDCP header based on identification of the header length field, and begin processing the PDCP header prior to ciphering.

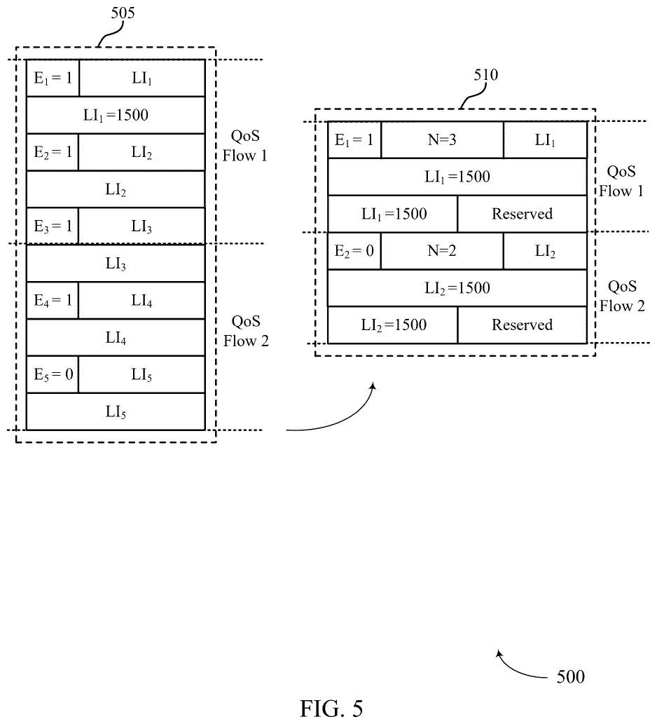

FIG. 5 shows an example of a PDU configuration 500 that supports PDCP concatenation and QoS header generation in accordance with one or more aspects of the present disclosure. For example, the PDU configuration 500 may be implemented at or by a transmitting device, such as a UE 115, a network entity 105 (e.g., a base station 140, a CU 160), or another device as described herein.

In some examples, such as for a PDCP PDU header configuration 505, the concatenation indicated by a PDCP PDU header may be a baseline (P0, P1, P2) concatenation that has 3 packets belonging to QoS flow 1 and 2 packets belonging to flow 2, where each packet has a length of 1500 bytes. The representation of the QoS flows of the PDCP PDU header configuration 505 may then be:

$$QoS flow 1 : ( L 1. L 2 L 3 ) = ( 1500 , 1500 , 1500 )$$

$$QoS flow 2 : ( L 4. L 5 ) = ( 1500 , 1500 )$$

In some such examples, consecutive packets corresponding to a QoS flow may have equal packet sizes (e.g., consecutive internet protocol (IP) packets of 1500 bytes, consecutive transmission control protocol (TCP) acknowledgment (ACK) messages of the same size).

In order to reduce processing complexity (e.g., L2 processing) and overhead compared to the QoS flow representation for the concatenated PDCP PDU header configuration 505, the transmitting device may represent concatenated packets that belong to the same QoS flow by representing each group of SDUs belonging to the same flow using (N,L) packet pairs, where N is the number or quantity of packets and L is the length of a packet. For example, the transmitting device may construct the PDCP PDU header, and may represent the QoS flows of the PDCP PDU header configuration 510 as:

$$QoS flow 1 : ( N 1 , L 1 ) = ( 3 , 1500 )$$

$$QoS flow 2 : ( N 2 , L 2 ) = ( 2 , 1500 )$$

In such examples, the QoS flow 1 may be represented as a first quantity of packets (e.g., N1) and a corresponding length of each packet (e.g., L1), and QoS flow 2 may be represented as a second quantity of packets (e.g., N2) and a corresponding length of each packet (e.g., L2).

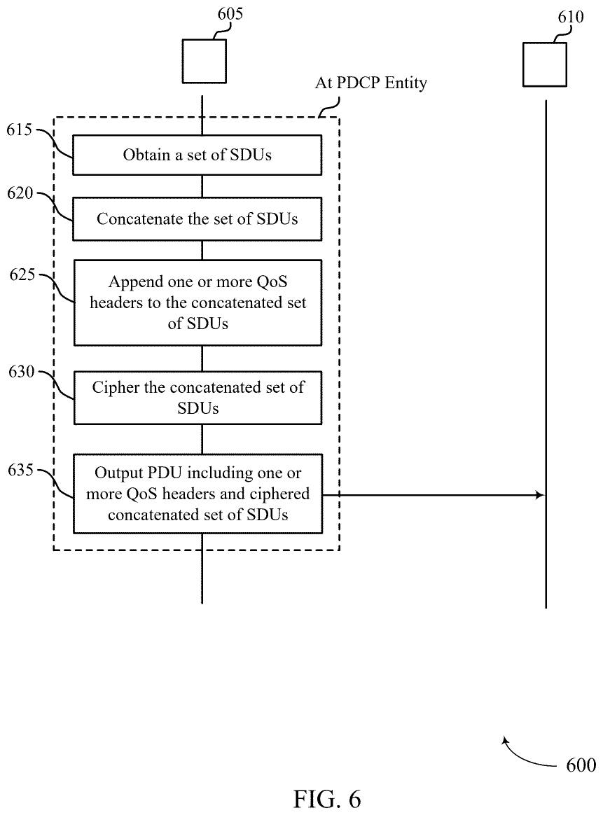

FIG. 6 shows an example of a process flow 600 that supports PDCP concatenation and QoS header generation in accordance with one or more aspects of the present disclosure. For example, the process flow 600 may illustrate a process flow or communications flow between a first device 605 and a second device 610. The first device 605 may be an example of a transmitting device, such as a UE 115, a network entity 105 (e.g., a base station 140, a transmitting CU 160), or another device as described herein. The second device 610 may be an example of a receiving device, such as a UE 115, a network entity 105 (e.g., a base station 140, a receiving CU 160), or another device as described herein.

Alternative examples of the following may be implemented. Some steps are performed in a different order than described herein or are not performed at all. In some implementations, steps may include additional features not mentioned below, or additional steps may be added. Further, although the first device 605 and the second device 610 are illustrated performing the operations of the process flow 600, some aspects of some operations may also be performed by one or more other network functions, network entities, or wireless communications devices.

At 615, the first device 605 may obtain, at a PDCP entity of the first device 105 (e.g., a PDCP entity 205), a set of SDUs. In some examples, the PDCP entity may provide services to upper layers of a protocol stack, including transferring of user plane and control plane data, header compression and decompression, ciphering and deciphering, integrity protection, among other functionalities. In some examples, the PDCP entity of the first device 105 may obtain the set of SDUs from an upper protocol layer (e.g., an RRC layer, an RRC entity, which may be included in the device 605 or different from the device 605), such as via a control service access point (C-SAP) interface.

At 620, the first device 605 may concatenate, at the PDCP entity, the set of SDUs to obtain a concatenated SDU (e.g., a concatenated SDU 225, a concatenated SDU 320).

At 625, the first device 605 may append, at the PDCP entity, one or more QoS headers (e.g., a QoS header 315) with the concatenated set of SDUs. In some examples, the first device 605 may append the one or more QoS headers with one or more concatenation headers (e.g., concatenation header 310, concatenation header 415). In some such examples, each QoS header may follow a respective concatenation header for a respective SDU of the set of SDUs. In some examples, the first device 605 may append the one or more QoS headers (e.g., a QoS header 315) with a concatenation header associated with the set of SDUs, and the one or more QoS headers may follow the concatenation header. In some examples, the one or more QoS headers may include at least a portion of a PDCP header (e.g., via PDCP header application 245). In some such examples, the PDCP header may include a length field that indicates a total length of the PDCP header.

In some aspects, the first device 605 may append, at the PDCP entity (e.g., PDCP entity 205), one or more concatenation headers associated with the concatenated set of SDUs. In some such aspects, for each SDU of the set of SDUs (e.g., SDU 1 through SDU N), a respective concatenation header may include an indication of whether a respective QoS header is included for a respective SDU in the one or more QoS headers. In some examples, the indication may additionally, or alternatively, indicate whether the respective QoS header is shared for the respective SDU and at least one SDU different than the respective SDU (e.g., an SDU occurring before or after the respective SDU) in the concatenated set of SDUs.

In some examples, the set of SDUs may include one or more groups of SDUs (e.g., SDUs corresponding to a QoS flow 1 or a QoS flow 2, as described with reference to FIGS. 4 and 5). In some such examples, each of the one or more groups of SDUs may correspond to respective QoS headers of the one or more QoS headers (e.g., QoS₁, QoS_{N}), and each group of the one or more groups of SDUs may be associated with an SDU quantity indicator (e.g., N) and a packet length indicator (e.g., L). For example, the SDU quantity indicator may indicate a quantity or number of SDUs that correspond to a same QoS header (and a same QoS flow), and the packet length indicator may indicate a quantity of bytes associated with the quantity of SDUs that correspond to the same QoS header (and the same QoS flow). In some examples, the first device 605 may append one or more concatenation headers (e.g., concatenation header 310, concatenation header 415) at the PDCP entity. In some such examples, a respective concatenation header includes an indication of whether a respective QoS header (e.g., QoS₁, QoS_{N}) is shared between SDUs of the respective group of SDUs.

At 630, the first device 605 may cipher, at the PDCP entity, the concatenated set of SDUs. In some examples, the first device 605 may cipher the concatenated set of SDUs (e.g., the concatenated SDU 225, a concatenated SDU 320) together with the one or more QoS headers (or separately from the set of QoS headers). That is, in some examples, the first device may cipher the QoS header together with the concatenated set of SDUs. Additionally, or alternatively, the first device 605 may refrain from ciphering the one or more QoS headers.

In some aspects, the first device 605 may receive or transmit (e.g., via control signaling such as RRC, MAC-CE, PDCP control signaling, or any combination thereof) an RQI, and RDI, or both, to indicate a mapping of the one or more QoS headers with the concatenated set of SDUs (e.g., the concatenated SDU 225, a concatenated SDU 320).

At 635, the first device 605 may output, via the PDCP entity, a PDU including the one or more QoS headers and the ciphered concatenated set of SDUs. The PDU may be processed by one or more downstream protocol layers (e.g., a protocol entity of the first device 605, a protocol entity of another device, not shown, or a combination thereof) for downstream wireless transmission to the second device 610.

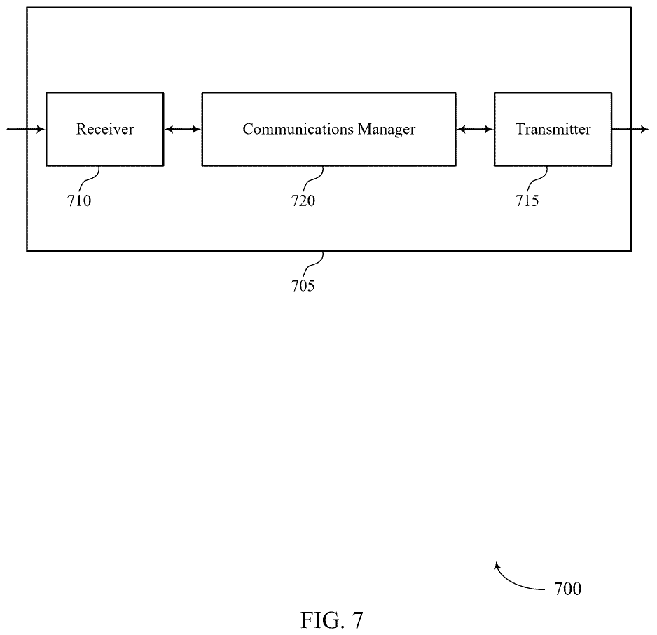

FIG. 7 shows a block diagram 700 of a device 705 that supports PDCP concatenation and QoS header generation in accordance with one or more aspects of the present disclosure. The device 705 may be an example of aspects of a UE 115 or a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to PDCP concatenation and QoS header generation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to PDCP concatenation and QoS header generation). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of PDCP concatenation and QoS header generation as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein (e.g., may be or include aspects of a PDCP entity). For example, the communications manager 720 is capable of, configured to, or operable to support a means for obtaining, at a PDCP entity, a set of multiple SDUs. The communications manager 720 is capable of, configured to, or operable to support a means for concatenating, at the PDCP entity, the set of multiple SDUs. The communications manager 720 is capable of, configured to, or operable to support a means for appending, at the PDCP entity, one or more QoS headers with the concatenated set of multiple SDUs. The communications manager 720 is capable of, configured to, or operable to support a means for ciphering, at the PDCP entity, the concatenated set of multiple SDUs. The communications manager 720 is capable of, configured to, or operable to support a means for outputting, from the PDCP entity, a protocol data unit including the one or more QoS headers and the ciphered concatenated set of multiple SDUs.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, more efficient utilization of communication resources, and reduced overhead. Additionally, or alternatively, the device 705 may support reduced processing (e.g., L2 processing) by reducing the total quantity of headers included in a PDCP header, by reducing ciphering and integrity protection operations performed by the transmitting device at the PDCP layer (e.g., by allowing for concatenating the SDUs prior to processing), and by condensing the representation of QoS headers included in a packet. Additionally, or alternatively, the device 1105 may support techniques as described herein for reducing transmission overhead, and may support improved integrity protection for ciphered packets.

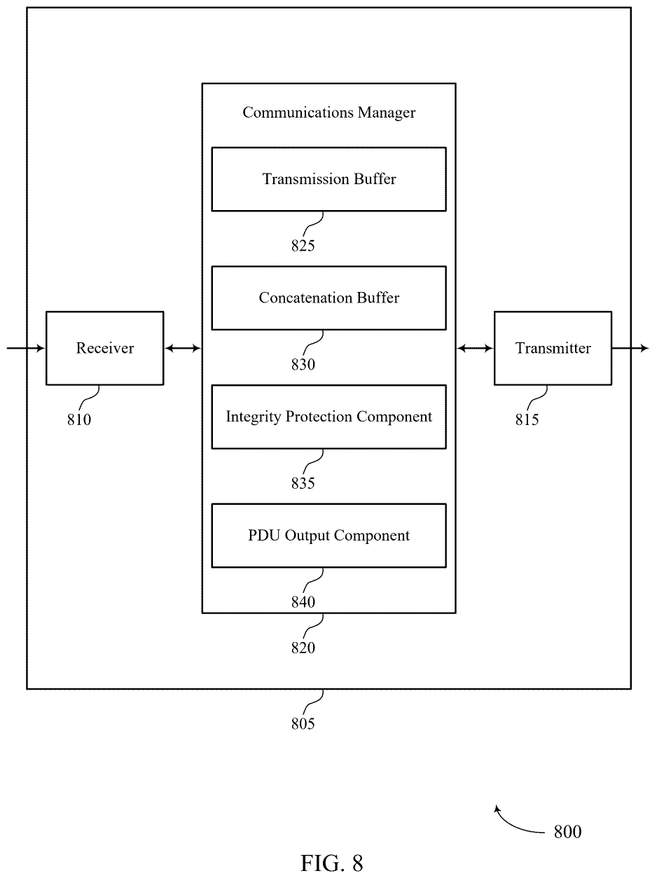

FIG. 8 shows a block diagram 800 of a device 805 that supports PDCP concatenation and QoS header generation in accordance with one or more aspects of the present disclosure. The device 805 may be an example of aspects of a device 705, a UE 115, or a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to PDCP concatenation and QoS header generation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to PDCP concatenation and QoS header generation). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of PDCP concatenation and QoS header generation as described herein (e.g., may be or include aspects of a PDCP entity). For example, the communications manager 820 may include a transmission buffer 825, a concatenation buffer 830, an integrity protection component 835, a PDU output component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The transmission buffer 825 is capable of, configured to, or operable to support a means for obtaining, at a PDCP entity, a set of multiple SDUs. The concatenation buffer 830 is capable of, configured to, or operable to support a means for concatenating, at the PDCP entity, the set of multiple SDUs. The concatenation buffer 830 is capable of, configured to, or operable to support a means for appending, at the PDCP entity, one or more QoS headers with the concatenated set of multiple SDUs. The integrity protection component 835 is capable of, configured to, or operable to support a means for ciphering, at the PDCP entity, the concatenated set of multiple SDUs. The PDU output component 840 is capable of, configured to, or operable to support a means for outputting, from the PDCP entity, a protocol data unit including the one or more QoS headers and the ciphered concatenated set of multiple SDUs.

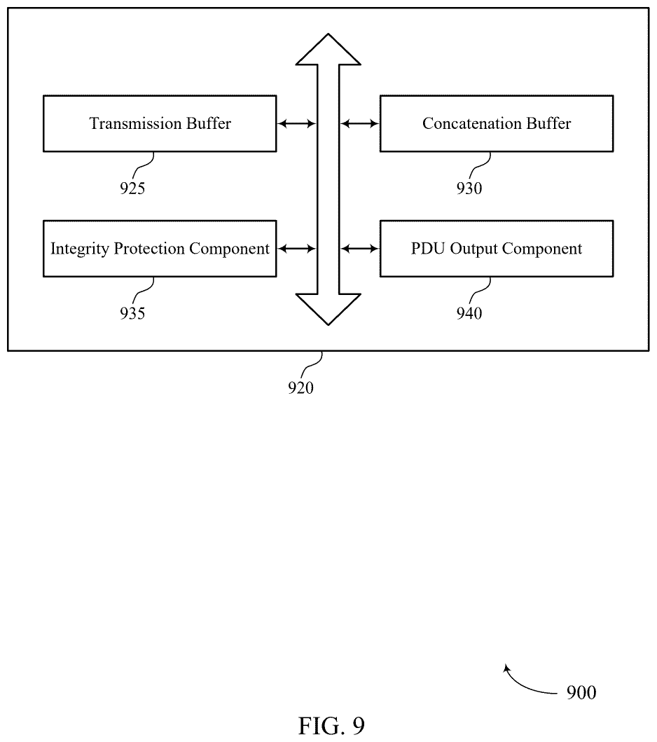

FIG. 9 shows a block diagram 900 of a communications manager 920 that supports PDCP concatenation and QoS header generation in accordance with one or more aspects of the present disclosure. The communications manager 920 may be an example of aspects of a communications manager 720, a communications manager 820, or both, as described herein. The communications manager 920, or various components thereof, may be an example of means for performing various aspects of PDCP concatenation and QoS header generation as described herein (e.g., may be or include aspects of a PDCP entity). For example, the communications manager 920 may include a transmission buffer 925, a concatenation buffer 930, an integrity protection component 935, a PDU output component 940, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 920 may support wireless communications in accordance with examples as disclosed herein. The transmission buffer 925 is capable of, configured to, or operable to support a means for obtaining, at a PDCP entity, a set of multiple SDUs. The concatenation buffer 930 is capable of, configured to, or operable to support a means for concatenating, at the PDCP entity, the set of multiple SDUs. In some examples, the concatenation buffer 930 is capable of, configured to, or operable to support a means for appending, at the PDCP entity, one or more QoS headers with the concatenated set of multiple SDUs. The integrity protection component 935 is capable of, configured to, or operable to support a means for ciphering, at the PDCP entity, the concatenated set of multiple SDUs. The PDU output component 940 is capable of, configured to, or operable to support a means for outputting, from the PDCP entity, a protocol data unit including the one or more QoS headers and the ciphered concatenated set of multiple SDUs.

In some examples, to support appending the one or more QoS headers, the concatenation buffer 930 is capable of, configured to, or operable to support a means for appending the one or more QoS headers with one or more concatenation headers, where each QoS header follows a respective concatenation header of the one or more concatenation headers for a respective SDU of the set of multiple SDUs.

In some examples, to support appending the one or more QoS headers, the concatenation buffer 930 is capable of, configured to, or operable to support a means for appending the one or more QoS headers with a concatenation header associated with the set of multiple SDUs, where the one or more QoS headers follow the concatenation header.

In some examples, the concatenation buffer 930 is capable of, configured to, or operable to support a means for appending, at the PDCP entity, one or more concatenation headers associated with the concatenated set of multiple SDUs, where, for each of the set of multiple SDUs, a respective concatenation header includes an indication of whether a respective QoS header is included for a respective SDU in the one or more QoS headers.

In some examples, the indication indicates whether the respective QoS header is shared for the respective SDU and at least one SDU different than the respective SDU in the concatenated set of multiple SDUs.

In some examples, the set of multiple SDUs include one or more groups of SDUs, each group of the one or more groups of SDUs corresponding to respective QoS headers of the one or more QoS headers, and each group of the one or more groups of SDUs is associated with a SDU quantity indicator and a packet length indicator. In some examples, the SDU quantity indicator indicates a quantity of SDUs that correspond to a same QoS header, and the packet length indicator indicates quantity of bytes associated with the quantity of SDUs that correspond to the same QoS header.

In some examples, the concatenation buffer 930 is capable of, configured to, or operable to support a means for appending one or more concatenation headers at the PDCP entity, where, for a respective group of SDUs, a respective concatenation header includes an indication of whether a respective QoS header is shared between SDUs of the respective group of SDUs. In some examples, the one or more QoS headers include at least a portion of a PDCP header, the PDCP header including a length field indicative of a total length of the PDCP header.

In some examples, the PDU output component 940 is capable of, configured to, or operable to support a means for outputting, via control signaling, an RQI, an RDI, or both, to indicate a mapping of the one or more QoS headers with the concatenated set of multiple SDUs. In some examples, the control signaling includes RRC signaling, MAC-CE signaling, PDCP signaling, or any combination thereof.

In some examples, to support ciphering the concatenated set of multiple SDUs, the integrity protection component 935 is capable of, configured to, or operable to support a means for ciphering the concatenated set of multiple SDUs together with the one or more QoS headers.

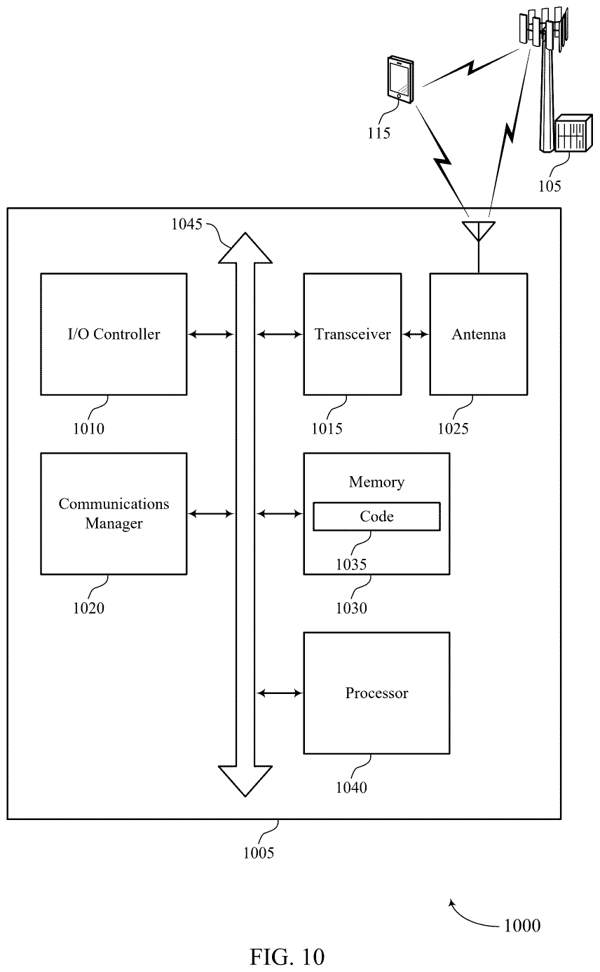

FIG. 10 shows a diagram of a system 1000 including a device 1005 that supports PDCP concatenation and QoS header generation in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting PDCP concatenation and QoS header generation). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein (e.g., may be or include aspects of a PDCP entity). For example, the communications manager 1020 is capable of, configured to, or operable to support a means for obtaining, at a PDCP entity, a set of multiple SDUs. The communications manager 1020 is capable of, configured to, or operable to support a means for concatenating, at the PDCP entity, the set of multiple SDUs. The communications manager 1020 is capable of, configured to, or operable to support a means for appending, at the PDCP entity, one or more QoS headers with the concatenated set of multiple SDUs. The communications manager 1020 is capable of, configured to, or operable to support a means for ciphering, at the PDCP entity, the concatenated set of multiple SDUs. The communications manager 1020 is capable of, configured to, or operable to support a means for outputting, from the PDCP entity, a protocol data unit including the one or more QoS headers and the ciphered concatenated set of multiple SDUs.

By including or configuring the communications manager 1020 in accordance with examples as described herein, the device 1005 may support techniques for improved communication reliability and security, improved user experience related to reduced processing, reduced power consumption, more efficient utilization of communication resources, improved coordination between devices, longer battery life, improved utilization of processing capability, reduced signaling overhead, and reduced ciphering and deciphering complexity. Additionally, or alternatively, the device 1005 may support reduced processing (e.g., L2 processing) by reducing the total quantity of headers included in a PDCP header, and by reducing ciphering and integrity protection operations performed by the transmitting device at the PDCP layer (e.g., by allowing for concatenating the SDUs prior to processing). Additionally, or alternatively, the device 1005 may support techniques as described herein for reducing transmission overhead, and may support improved integrity protection for ciphered packets.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of PDCP concatenation and QoS header generation as described herein, or the at least one processor 1040 and the at least one memory 1030 may be otherwise configured to, individually or collectively, perform or support such operations.

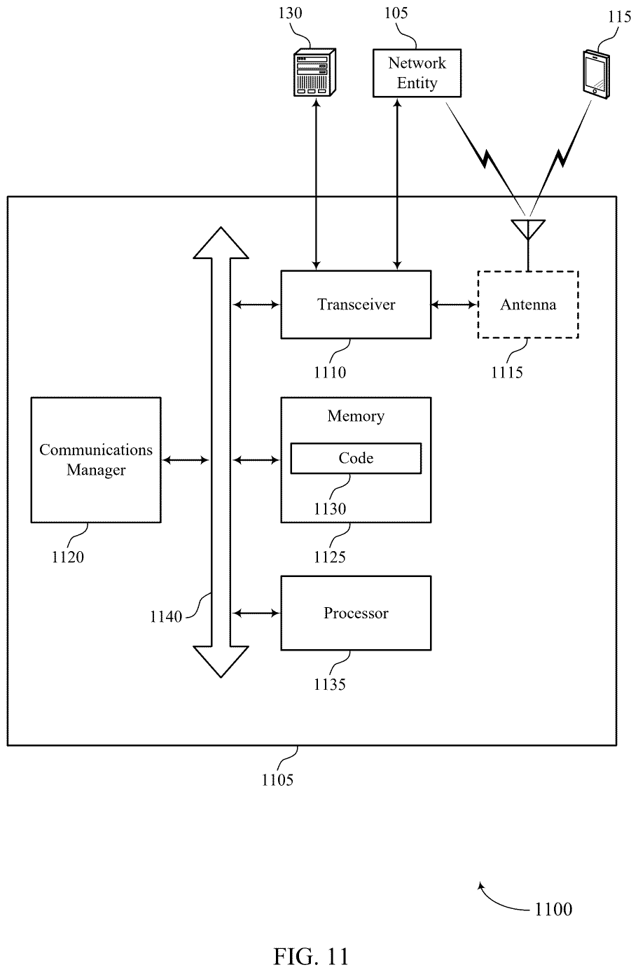

FIG. 11 shows a diagram of a system 1100 including a device 1105 that supports PDCP concatenation and QoS header generation in accordance with one or more aspects of the present disclosure. The device 1105 may be an example of or include components of a device 705, a device 805, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting PDCP concatenation and QoS header generation). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein (e.g., may be or include aspects of a PDCP entity). For example, the communications manager 1120 is capable of, configured to, or operable to support a means for obtaining, at a PDCP entity, a set of multiple SDUs. The communications manager 1120 is capable of, configured to, or operable to support a means for concatenating, at the PDCP entity, the set of multiple SDUs. The communications manager 1120 is capable of, configured to, or operable to support a means for appending, at the PDCP entity, one or more QoS headers with the concatenated set of multiple SDUs. The communications manager 1120 is capable of, configured to, or operable to support a means for ciphering, at the PDCP entity, the concatenated set of multiple SDUs. The communications manager 1120 is capable of, configured to, or operable to support a means for outputting, from the PDCP entity, a protocol data unit including the one or more QoS headers and the ciphered concatenated set of multiple SDUs.

By including or configuring the communications manager 1120 in accordance with examples as described herein, the device 1105 may support techniques for improved communication reliability and security, improved user experience related to reduced power consumption, more efficient utilization of communication resources, improved coordination between devices, longer battery life, improved utilization of processing capability, reduced signaling overhead, and reduced ciphering and deciphering complexity. Additionally, or alternatively, the device 1105 may support reduced processing (e.g., L2 processing) by reducing the total quantity of headers included in a PDCP header, and reducing ciphering and integrity protection operations performed by the transmitting device at the PDCP layer (e.g., by allowing for concatenating the SDUs prior to processing). Additionally, or alternatively, the device 1105 may support techniques as described herein for reducing transmission overhead, and may support improved integrity protection for ciphered packets.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of PDCP concatenation and QoS header generation as described herein, or the at least one processor 1135 and the at least one memory 1125 may be otherwise configured to, individually or collectively, perform or support such operations.

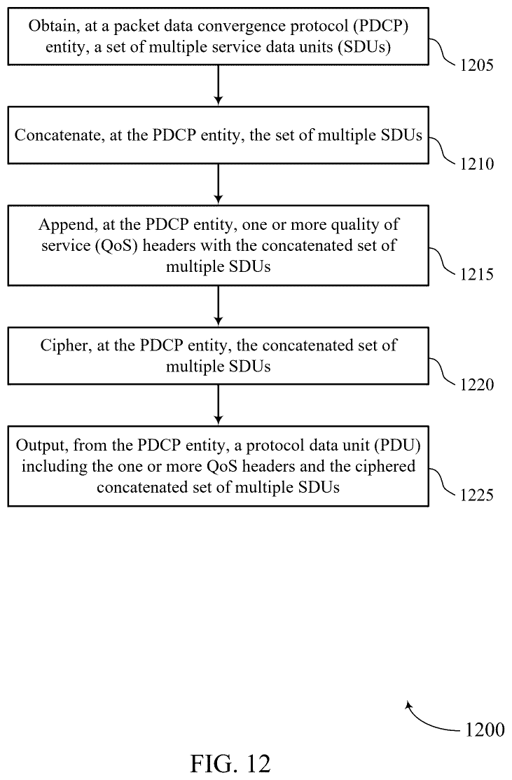

FIG. 12 shows a flowchart illustrating a method 1200 that supports PDCP concatenation and QoS header generation in accordance with one or more aspects of the present disclosure. The operations of the method 1200 may be implemented by a UE or a network entity or its components (e.g., a PDCP entity) as described herein. For example, the operations of the method 1200 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include obtaining, at a PDCP entity, a set of multiple SDUs. The operations of 1205 may be performed in accordance with examples as disclosed herein, such as such as in accordance with the obtaining of the set of SDUs at 615 of FIG. 6. The multiple SDUs may be an example of the concatenated SDU 320 of the concatenated SDU configuration 300-a of FIG. 3. In some examples, aspects of the operations of 1205 may be performed by a transmission buffer 925 as described with reference to FIG. 9. Additionally, or alternatively, aspects of the operations of 1205 may be performed by the device 1005 in association with the at least one processor 1040 executing the code 1035 stored in the at least one memory 1030, as described with reference to FIG. 10, or may be performed by the device 1105 in association with the at least one processor 1135 executing the code 1130 stored in the at least one memory 1125, as described with reference to FIG. 11.

At 1210, the method may include concatenating, at the PDCP entity, the set of multiple SDUs. The operations of 1210 may be performed in accordance with examples as disclosed herein, such as such as in accordance with the concatenation of the set of SDUs at 620 of FIG. 6. The multiple SDUs may be an example of the concatenated SDU 320 of the concatenated SDU configuration 300-a of FIG. 3. In some examples, aspects of the operations of 1210 may be performed by a concatenation buffer 930 as described with reference to FIG. 9. Additionally, or alternatively, aspects of the operations of 1210 may be performed by the device 1005 in association with the at least one processor 1040 executing the code 1035 stored in the at least one memory 1030, as described with reference to FIG. 10, or may be performed by the device 1105 in association with the at least one processor 1135 executing the code 1130 stored in the at least one memory 1125, as described with reference to FIG. 11.

At 1215, the method may include appending, at the PDCP entity, one or more QoS headers with the concatenated set of multiple SDUs. The operations of 1215 may be performed in accordance with examples as disclosed herein, such as such as in accordance with the appending of the one or more QoS headers to the concatenated set of SDUs at 625 of FIG. 6. The QoS headers may be an example of the QoS header 340 of the concatenated SDU configuration 300-b of FIG. 3. In some examples, aspects of the operations of 1215 may be performed by a concatenation buffer 930 as described with reference to FIG. 9. Additionally, or alternatively, aspects of the operations of 1215 may be performed by the device 1005 in association with the at least one processor 1040 executing the code 1035 stored in the at least one memory 1030, as described with reference to FIG. 10, or may be performed by the device 1105 in association with the at least one processor 1135 executing the code 1130 stored in the at least one memory 1125, as described with reference to FIG. 11.

At 1220, the method may include ciphering, at the PDCP entity, the concatenated set of multiple SDUs. The operations of 1220 may be performed in accordance with examples as disclosed herein, such as such as in accordance with the ciphering of the concatenated set of multiple SDUs at 630 of FIG. 6. The ciphering may be an example of the ciphering of the concatenated SDU 320 of the concatenated SDU configuration 300-a of FIG. 3. In some examples, aspects of the operations of 1220 may be performed by an integrity protection component 935 as described with reference to FIG. 9. Additionally, or alternatively, aspects of the operations of 1220 may be performed by the device 1005 in association with the at least one processor 1040 executing the code 1035 stored in the at least one memory 1030, as described with reference to FIG. 10, or may be performed by the device 1105 in association with the at least one processor 1135 executing the code 1130 stored in the at least one memory 1125, as described with reference to FIG. 11.

At 1225, the method may include outputting, from the PDCP entity, a PDU including the one or more QoS headers and the ciphered concatenated set of multiple SDUs. The operations of 1225 may be performed in accordance with examples as disclosed herein, such as such as in accordance with the outputting of the PDU at 635 of FIG. 6. The PDU may be an example of any of the PDUs illustrated in FIGS. 3 through 5. In some examples, aspects of the operations of 1225 may be performed by a PDU output component 940 as described with reference to FIG. 9. Additionally, or alternatively, aspects of the operations of 1225 may be performed by the device 1005 in association with the at least one processor 1040 executing the code 1035 stored in the at least one memory 1030, as described with reference to FIG. 10, or may be performed by the device 1105 in association with the at least one processor 1135 executing the code 1130 stored in the at least one memory 1125, as described with reference to FIG. 11.

The following provides an overview of aspects of the present disclosure:

Aspect 1: A method for wireless communications, comprising: obtaining, at a PDCP entity, a plurality of SDUs; concatenating, at the PDCP entity, the plurality of SDUs; appending, at the PDCP entity, one or more QoS headers with the concatenated plurality of SDUs; ciphering, at the PDCP entity, the concatenated plurality of SDUs; and outputting, from the PDCP entity, a PDU including the one or more QoS headers and the ciphered concatenated plurality of SDUs.

Aspect 2: The method of aspect 1, wherein appending the one or more QoS headers comprises: appending the one or more QoS headers with one or more concatenation headers, wherein each QoS header follows a respective concatenation header of the one or more concatenation headers for a respective SDU of the plurality of SDUs.

Aspect 3: The method of any of aspects 1 through 2, wherein appending the one or more QoS headers comprises: appending the one or more QoS headers with a concatenation header associated with the plurality of SDUs, wherein the one or more QoS headers follow the concatenation header.

Aspect 4: The method of any of aspects 1 through 3, further comprising: appending, at the PDCP entity, one or more concatenation headers associated with the concatenated plurality of SDUs, wherein, for each of the plurality of SDUs, a respective concatenation header includes an indication of whether a respective QoS header is included for a respective SDU in the one or more QoS headers.

Aspect 5: The method of aspect 4, wherein the indication indicates whether the respective QoS header is shared for the respective SDU and at least one SDU different than the respective SDU in the concatenated plurality of SDUs.

Aspect 6: The method of any of aspects 1 through 5, wherein the plurality of SDUs comprise one or more groups of SDUs, each group of the one or more groups of SDUs corresponding to respective QoS headers of the one or more QoS headers, and each group of the one or more groups of SDUs is associated with a SDU quantity indicator and a packet length indicator.

Aspect 7: The method of aspect 6, wherein the SDU quantity indicator indicates a quantity of SDUs that correspond to a same QoS header, and the packet length indicator indicates quantity of bytes associated with the quantity of SDUs that correspond to the same QoS header.

Aspect 8: The method of any of aspects 6 through 7, further comprising: appending one or more concatenation headers at the PDCP entity, wherein, for a respective group of SDUs, a respective concatenation header includes an indication of whether a respective QoS header is shared between SDUs of the respective group of SDUs.

Aspect 9: The method of any of aspects 1 through 8, wherein the one or more QoS headers comprise at least a portion of a PDCP header, the PDCP header including a length field indicative of a total length of the PDCP header.

Aspect 10: The method of any of aspects 1 through 9, further comprising: outputting, via control signaling, an RQI, an RDI, or both, to indicate a mapping of the one or more QoS headers with the concatenated plurality of SDUs.

Aspect 11: The method of aspect 10, wherein the control signaling comprises RRC signaling, MAC-CE signaling, PDCP signaling, or any combination thereof.

Aspect 12: The method of any of aspects 1 through 11, wherein ciphering the concatenated plurality of SDUs comprises: ciphering the concatenated plurality of SDUs together with the one or more QoS headers.

Aspect 13: An apparatus for wireless communications, comprising one or more memories storing processor-executable code, and one or more processors coupled with the one or more memories and individually or collectively operable to execute the code to cause the apparatus to perform a method of any of aspects 1 through 12.

Aspect 14: An apparatus for wireless communications, comprising at least one means for performing a method of any of aspects 1 through 12.

Aspect 15: A non-transitory computer-readable medium storing code for wireless communications, the code comprising instructions executable by one or more processors to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless communications device, comprising:
one or more memories storing processor-executable code; and
one or more processors coupled with the one or more memories and individually or collectively operable to execute the code to cause the wireless communications device to:
obtain, at a packet data convergence protocol (PDCP) entity, a plurality of service data units;
concatenate, at the PDCP entity, the plurality of service data units;
appending, at the PDCP entity, one or more quality of service (QoS) headers with the concatenated plurality of service data units;
cipher, at the PDCP entity, the concatenated plurality of service data units; and
output, from the PDCP entity, a protocol data unit including the one or more QoS headers and the ciphered concatenated plurality of service data units.

2. The wireless communications device of claim 1, wherein, to append the one or more QoS headers, the one or more processors are individually or collectively operable to execute the code to cause the wireless communications device to:
append the one or more QoS headers with one or more concatenation headers, wherein each QoS header follows a respective concatenation header of the one or more concatenation headers for a respective service data unit of the plurality of service data units.

3. The wireless communications device of claim 1, wherein, to append the one or more QoS headers, the one or more processors are individually or collectively operable to execute the code to cause the wireless communications device to:
append the one or more QoS headers with a concatenation header associated with the plurality of service data units, wherein the one or more QoS headers follow the concatenation header.

4. The wireless communications device of claim 1, wherein the one or more processors are individually or collectively further operable to execute the code to cause the wireless communications device to:
append, at the PDCP entity, one or more concatenation headers associated with the concatenated plurality of service data units, wherein, for each of the plurality of service data units, a respective concatenation header includes an indication of whether a respective QoS header is included for a respective service data unit in the one or more QoS headers.

5. The wireless communications device of claim 4, wherein the indication indicates whether the respective QoS header is shared for the respective service data unit and at least one service data unit different than the respective service data unit in the concatenated plurality of service data units.

6. The wireless communications device of claim 1, wherein:
the plurality of service data units comprise one or more groups of service data units, each group of the one or more groups of service data units corresponding to respective QoS headers of the one or more QoS headers; and
each group of the one or more groups of service data units is associated with a service data unit quantity indicator and a packet length indicator.

7. The wireless communications device of claim 6, wherein:
the service data unit quantity indicator indicates a quantity of service data units that correspond to a same QoS header; and
the packet length indicator indicates quantity of bytes associated with the quantity of service data units that correspond to the same QoS header.

8. The wireless communications device of claim 6, wherein the one or more processors are individually or collectively further operable to execute the code to cause the wireless communications device to:
append one or more concatenation headers at the PDCP entity, wherein, for a respective group of service data units, a respective concatenation header includes an indication of whether a respective QoS header is shared between service data units of the respective group of service data units.

9. The wireless communications device of claim 1, wherein the one or more QoS headers comprise at least a portion of a PDCP header, the PDCP header including a length field indicative of a total length of the PDCP header.

10. The wireless communications device of claim 1, wherein the one or more processors are individually or collectively further operable to execute the code to cause the wireless communications device to:
output, via control signaling, a reflective QoS indicator (RQI), a reflective QoS to data radio bearer (DRB) mapping indicator (RDI), or both, to indicate a mapping of the one or more QoS headers with the concatenated plurality of service data units.

11. The wireless communications device of claim 10, wherein the control signaling comprises radio resource control (RRC) signaling, medium access control-control element (MAC-CE) signaling, PDCP signaling, or any combination thereof.

12. The wireless communications device of claim 1, wherein, to cipher the concatenated plurality of service data units, the one or more processors are individually or collectively operable to execute the code to cause the wireless communications device to:
cipher the concatenated plurality of service data units together with the one or more QoS headers.

13. A method for wireless communications, comprising:
obtaining, at a packet data convergence protocol (PDCP) entity, a plurality of service data units;
concatenating, at the PDCP entity, the plurality of service data units;
appending, at the PDCP entity, one or more quality of service (QoS) headers with the concatenated plurality of service data units;
ciphering, at the PDCP entity, the concatenated plurality of service data units; and
outputting, from the PDCP entity, a protocol data unit including the one or more QoS headers and the ciphered concatenated plurality of service data units.

14. The method of claim 13, wherein appending the one or more QoS headers comprises:
appending the one or more QoS headers with one or more concatenation headers, wherein each QoS header follows a respective concatenation header of the one or more concatenation headers for a respective service data unit of the plurality of service data units.

15. The method of claim 13, wherein appending the one or more QoS headers comprises:
appending the one or more QoS headers with a concatenation header associated with the plurality of service data units, wherein the one or more QoS headers follow the concatenation header.

16. The method of claim 13, further comprising:
appending, at the PDCP entity, one or more concatenation headers associated with the concatenated plurality of service data units, wherein, for each of the plurality of service data units, a respective concatenation header includes an indication of whether a respective QoS header is included for a respective service data unit in the one or more QoS headers.

17. The method of claim 16, wherein the indication indicates whether the respective QoS header is shared for the respective service data unit and at least one service data unit different than the respective service data unit in the concatenated plurality of service data units.

18. The method of claim 13, wherein:
the plurality of service data units comprise one or more groups of service data units, each group of the one or more groups of service data units corresponding to respective QoS headers of the one or more QoS headers; and
each group of the one or more groups of service data units is associated with a service data unit quantity indicator and a packet length indicator.

19. The method of claim 18, wherein:
the service data unit quantity indicator indicates a quantity of service data units that correspond to a same QoS header; and
the packet length indicator indicates quantity of bytes associated with the quantity of service data units that correspond to the same QoS header.

20. A wireless communications device, comprising:
means for obtaining, at a packet data convergence protocol (PDCP) entity, a plurality of service data units;
means for concatenating, at the PDCP entity, the plurality of service data units;
means for appending, at the PDCP entity, one or more quality of service (QoS) headers with the concatenated plurality of service data units;
means for ciphering, at the PDCP entity, the concatenated plurality of service data units; and
means for outputting, from the PDCP entity, a protocol data unit including the one or more QoS headers and the ciphered concatenated plurality of service data units.
